(19) United States
(12) Patent Application Publication
(10) Pub. No.: US 2019/0387330 A1
(43) Pub. Date: Dec. 19, 2019

(54) METHOD FOR CONTROLLING THE TRANSMISSION OF DATA BETWEEN AT LEAST ONE HEARING AID AND A PERIPHERAL DEVICE OF A HEARING AID SYSTEM AND ALSO A HEARING AID

(71) Applicant: SIVANTOS PTE. LTD., Singapore (SG)

(72) Inventors: GOTTFRIED RUECKERL, NUERNBERG (DE); RICCARDO CAVALLARI, ERLANGEN (DE); STEFAN MIJOVIC, ERLANGEN (DE); RICARDO MORALES RAMOS, ERLANGEN (DE)

(21) Appl. No.: 16/444,083

(22) Filed: Jun. 18, 2019

(30) Foreign Application Priority Data
Jun. 18, 2018 (DE) 102018209822.0

(51) Int. Cl. H04R 25/00

(52) U.S. Cl. CPC H04R 25/554

(57) ABSTRACT

A method controls the transmission of data between at least one hearing aid and a peripheral device of a hearing aid system. A microphone signal captured by the hearing aid is automatically examined for own voice components of the hearing aid wearer, and wherein, on the recognition of own voice components, a subsequent audio sequence of the microphone signal is transmitted from the hearing aid to the peripheral device. A hearing aid can be configured as part of a hearing aid system for carrying out the method described above.

### CROSS-REFERENCE TO RELATED APPLICATION

This application claims the priority, under 35 U.S.C. § 119, of German application DE 10 2018 209 822.0, filed Jun. 18, 2018; the prior application is herewith incorporated by reference in its entirety.

### BACKGROUND OF THE INVENTION

### Field of the Invention

The invention relates to a method for controlling the transmission of data between at least one hearing aid and a peripheral device of a hearing aid system The invention further relates to a hearing aid for carrying out such a method.

The purpose of a hearing aid is to provide a person with impaired hearing with acoustic environmental signals that are appropriately processed and, in particular, amplified, to compensate for the particular hearing impairment. For this purpose a hearing aid usually contains an input transducer in the form, for example, of a microphone, a signal processing unit with an amplifier, and an output transducer. The output transducer is as a rule realized as a miniature loudspeaker, and is also referred to as an earpiece or receiver. In particular it generates acoustic output signals that are guided to the hearing organs of the patient and therein generate the desired hearing perception.

Hearing aids with different structural forms are offered in order to meet the large number of individual requirements. In the so-called behind-the-ear (BTE) hearing aids, a housing containing components such as a battery and the signal processing unit is worn behind the ear. Depending on the design, the receiver can be arranged directly in the auditory canal of the wearer (so-called receiver-in-canal (RIC) hearing aids). The receiver is, alternatively, arranged inside the housing itself, and a flexible sound tube, also referred to as the tube, guides the acoustic output signals of the receiver from the housing to the auditory canal (tube hearing aids). In in-the-ear (ITE) hearing aids a housing that contains all of the functional components, including the microphone and the receiver, is at least partially worn in the auditory canal. Completely-in-canal (CIC) hearing aids are similar to the ITE hearing aids, but are worn entirely inside the auditory canal.

In order to allow wireless communication between a hearing aid and an external peripheral device such as a smartphone, wireless technologies (abbreviated: RF, e.g. Bluetooth, Bluetooth LE or similar technologies) are now often used for transmission. No additional external devices are necessary here for wireless communication.

This transmission standard offers for example, the possibility of sending an audio stream, that is to say audio signals, from a hearing aid to a smartphone coupled thereto. This can be done, for example, for the purpose of using a voice control system managed by the smartphone. The smartphone here receives the audio stream and passes it on to applications that analyze the audio stream and generate control activities from the voice content of the audio stream (e.g. voice-controlled dialling, opening and closing applications, or the like).

An implementation of a function such as described above is also fundamentally possible in a hearing system. For this purpose, an audio stream originating from the hearing aid must be continuously transmitted via the wireless RF connection to an appropriate smartphone. Continuous transmission of data, however, raises the data traffic on the wireless RF connection, and thereby also the current consumption of the hearing aid, considerably. This has a negative effect on, for example, the battery life of the hearing aid.

It would alternatively be possible for the hearing aid itself to analyze the level of the audio signal, and only then to activate the RF connection when the sound level lies well above a predefined threshold value. This method does not, however, stop the RF connection from also being activated by loud noises from the surroundings. The voice level of the voice can in fact vary over quite a large range. Even if the audio signal were checked for typical, voice-like modulations, the origin could also be another speaker, and not the true wearer of the hearing aid.

### SUMMARY OF THE INVENTION

The invention is therefore based on the object of providing an efficient and energy-saving possibility for the transmission of an audio stream from a hearing aid to a peripheral device.

The method according to the invention is used for controlling the transmission of data between at least one hearing aid and a peripheral device of a hearing aid system. In the context of the method, a microphone signal captured by the hearing aid is automatically examined for own voice components of the hearing aid wearer, and, on the recognition of own voice components, a subsequent audio sequence of the microphone signal is transmitted from the hearing aid to the peripheral device.

The transmission of data between the hearing aid and the peripheral device is thus only activated when own voice components, i.e. voice sequences or components of the hearing aid wearer in the microphone signal, are recognized in the microphone signal picked up by the hearing aid. Accordingly, only the hearing aid wearer himself can initiate the transmission of data to the peripheral device. Other audio signals such as, for example, voice signals from conversation partners or from a radio playing in the background, that are picked up by the microphone of the hearing aid (as appropriate microphone signals), do not initiate the transmission of data. On the one hand this limits the activity of the hearing aid and reduces the current consumption of the hearing aid components, since the data or signal transmission only takes place when this is actually required or is desired by the hearing aid wearer. The individual method steps in particular take place automatically.

To verify a segment of the microphone signal (audio signal) containing own voice components of the hearing aid wearer, the hearing aid expediently contains an appropriate voice recognition module (as a separate component or as a part of the signal processing unit). The microphone signal itself contains all the acoustic information such as noises from the surroundings related to the situation, music, or also voice signals. An “own voice detection” module is expediently used in order to verify whether the microphone signal contains sequences in which own voice components of the hearing aid wearer are present. Only then is the subsequent audio sequence transmitted to the peripheral device that is coupled to the hearing aid.

In principle, all devices that can be coupled to a hearing aid for transmission of data can be used as the peripheral device. Bluetooth-capable peripheral devices are, in particular, employed. It is particularly preferred if a smartphone is employed as the peripheral device as a part of the hearing aid system.

The transmission of the audio sequence to the peripheral device is expediently ended when own voice components are no longer recognized in the audio sequence. In particular, after the recognition of own voice components in the microphone signal, the audio sequence is transmitted to the peripheral device only when and for as long as own voice components of the hearing aid wearer are recognized in the audio sequence. This means, in other words, that when own voice components are no longer recognized in the audio sequence transmitted to the peripheral device, the transmission is stopped after a previously specified delay time, or is at least temporarily interrupted. The transmission of data is expediently continued or restarted when own voice components of the hearing aid wearer are detected once more in the microphone signal.

In one preferred embodiment, after the recognition of own voice components in the microphone signal, the subsequent audio sequence of the microphone signal is transmitted from the hearing aid to the peripheral device for a predefined period of time Δt. In the context of the invention, a predefined period of time Δt refers in particular to a transmission time window—for example having a duration of 30 seconds. Within this period of time Δt, or the transmission time window, the audio sequence is sent to the peripheral device. After the period of time Δt has elapsed, the transmission is expediently interrupted. Alternatively the transmission of the audio sequence is preferably extended beyond the predefined period of time Δt if audio signals containing further own voice components of the hearing aid wearer are detected within the period of time Δt (the transmission time window). The transmission is then expediently extended from this point in time by a further period of time Δt.

The reaction time of the peripheral device coupled to the hearing aid is in particular taken into account in the context of the invention. Voice recognition algorithms of peripheral devices such as, for example, smartphones, are as a rule configured in such a way that a voice analysis—which thus in the present case is, in particular, an analysis of the audio sequence sent from the hearing aid—is only started by the peripheral device after receiving a special keyword (“Hey Google” to start a search engine, for example). There is the risk here that if a reaction time of the own voice recognition by the hearing aid, taking into account the subsequent activation time of the transmission of the audio sequence to the peripheral device, is too long, the total length of time is too long to permit the complete transmission of the keyword to the peripheral device. It would not in this case be possible for the keyword to be taken into account by the peripheral device.

Accordingly a buffer sequence that precedes the audio sequence in time is advantageously recorded continuously by the hearing aid and is stored therein. The buffer sequence is a partial sequence of the microphone signal that may contain own voice components which partial sequence is temporarily stored on an ongoing basis in the hearing aid. As soon as the transmission of the audio sequence from the hearing aid to the peripheral device is triggered by the own voice detection in the microphone signal, the buffer sequence recorded up to this point in time is transmitted from the hearing aid to the peripheral device as, so to speak, a “snapshot”. By transmitting the buffer sequence, a partial sequence of the microphone signal preceding the own voice recognition is thus also transmitted. It is in this way ensured that, for example, a keyword that is required for the initialization of the voice recognition software of a peripheral device that was already spoken before the transmission of the audio sequence is also received by the peripheral device. The partial sequence of the audio signal that follows the transmitted buffer sequence is then transmitted immediately after the buffer sequence, with a time delay to the peripheral device.

The storage time for the buffer sequence is expediently sufficiently long to bridge the time up to the beginning of the transmission of the audio sequence. As soon as the audio sequence is transmitted, a period of time that is long to a sufficient extent (3 seconds, for example) of the inactive voice is expediently used to switch over again to the original microphone signal. This can, optionally, also be done in the context of the invention step by step, until the non-delayed signal is reached.

In one possible embodiment of the invention, the buffer sequence is transmitted from the hearing aid to the peripheral device before the transmission of the audio sequence. In a further possible embodiment, on the recognition of own voice components, the buffer sequence stored up to this point in time is transmitted to the peripheral device together with the audio sequence. Thus if own voice components are recognized in the microphone signal (before the actual start of the transmission) or in the audio sequence (after transmission has already begun), the audio sequence and the buffer sequence are transmitted to the peripheral device simultaneously.

The audio sequence of the microphone signal and/or the recorded buffer sequence are preferably transmitted wirelessly from the hearing aid to the peripheral device. In particular, the at least one recognized key sequence and/or the audio signal are transmitted by a current-efficient RF transmission system. The transmission takes place preferably by means of Bluetooth LE (BLE), which has a lower current consumption in comparison with “classic” Bluetooth.

The hearing aid system according to the invention is configured for carrying out the method described above. The hearing aid system contains at least one hearing aid which in turn comprises at least one microphone for recording a microphone signal, a voice recognition module for examining the microphone signal for own voice components of the hearing aid wearer, as well as a transmission unit which is configured to transmit, on the recognition of own voice components, a subsequent audio sequence of the microphone signal from the hearing aid to the peripheral device.

The hearing aid system in particular comprises two hearing aids (binaurally coupled hearing aid system). It is thus a binaural hearing aid system. The two hearing aids of the hearing aid system are expediently coupled via a magnetic link, so that the algorithms underlying the own voice recognition (OVD algorithm) exchange correspondingly data between both hearing aids.

The transmission unit of the at least one hearing aid is preferably configured to transmit the audio sequence to the peripheral device only when and for as long as own voice components of the hearing aid wearer are recognized in the audio sequence. It is ensured in this way that a necessary initialization of the voice recognition software of a peripheral device takes place.

It is further preferred for the transmission unit of the at least one hearing aid to be configured to transmit, after the recognition of own voice components, the subsequent audio sequence of the microphone signal from the hearing aid to the peripheral device for a predefined period of time. Thus if own voice components are no longer recognized in the audio sequence transmitted to the peripheral device, the transmission is stopped or at least temporarily interrupted. In this case, the transmission unit reduces energy-intensive transmission activities.

In a particularly advantageous embodiment of the invention, the hearing aid contains a recording unit for the continuous recording and storage of a buffer sequence that precedes the audio sequence in time. The buffer sequence is a partial sequence of the microphone signal containing the own voice components, and is transmitted from the hearing aid to the peripheral device as soon as the transmission of the audio sequence from the hearing aid to the peripheral device is triggered by the own voice recognition in the microphone signal.

This means, in other words, that the transmission of the delayed signal to the peripheral device is started at the point in time of triggering the own voice recognition. The length of the time delay is composed here of the typical response time of the own voice recognition and the period of time required for the full functional capability of the RF link. A respectively suitably delayed audio signal is thus always used for the voice control function.

The transmission unit of the at least one hearing aid is preferably configured to transmit the buffer sequence from the hearing aid to the peripheral device before the transmission of the audio sequence.

The transmission unit of the at least one hearing aid is preferably configured to transmit the audio sequence of the microphone signal and/or the recorded buffer sequence wirelessly from the hearing aid to the peripheral device.

The at least one hearing aid expediently contains RF transmission electronics including an RF antenna.

The advantages and preferred forms of embodiment described for the method according to the invention apply equally well to the hearing aid according to the invention, and can accordingly be transferred to it analogously.

Other features which are considered as characteristic for the invention are set forth in the appended claims.

Although the invention is illustrated and described herein as embodied in a method for controlling the transmission of data between at least one hearing aid and a peripheral device of a hearing aid system and also a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is schematic illustration of a hearing aid system with a hearing aid and a smartphone as a peripheral device according to the invention; and

FIG. 2 is a flow chart of a process for transmission of data between the hearing aid and the peripheral device according to the invention.

### DETAILED DESCRIPTION OF THE INVENTION

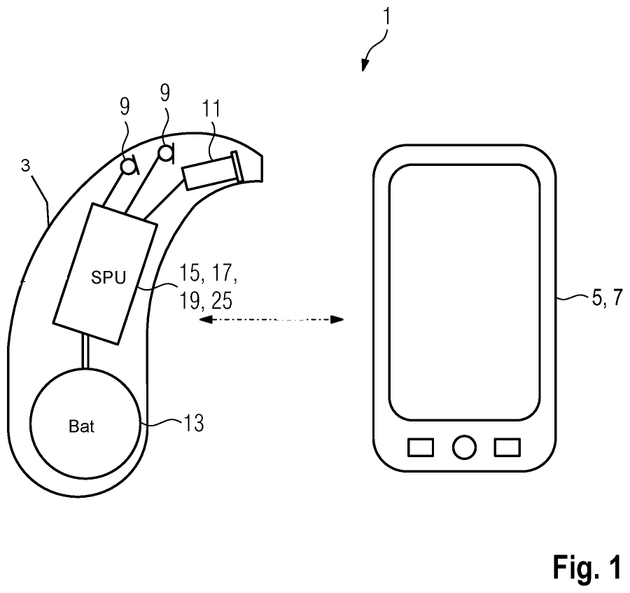

Referring now to the figures of the drawings in detail and first, particularly to FIG. 1 thereof, there is shown a schematic illustration of a hearing aid system 1 with a hearing aid 3 and a peripheral device 7 in the form of a smartphone 5. The hearing aid 3 has two microphones 9, an earpiece or receiver 11, and a battery 13. The hearing aid 3 further has a signal processing unit 15 with a voice recognition module 17 for examining the microphone signal for own voice components of the hearing aid wearer, as well as a transmission unit 19 by means of which, on the recognition of own voice components, a subsequent audio sequence of the microphone signal is transmitted from the hearing aid 3 to the peripheral device 7.

The hearing aid 3 is coupled to the smartphone 5 via low-current RF transmission technology, so that a transmission of data can take place between the two components of the hearing aid system 1. The transmission of data is initiated at the point in time when own voice components, that is to say an audio sequence with voice signals spoken by the hearing aid wearer, are recognized in the microphone signal recorded by the hearing aid 3.

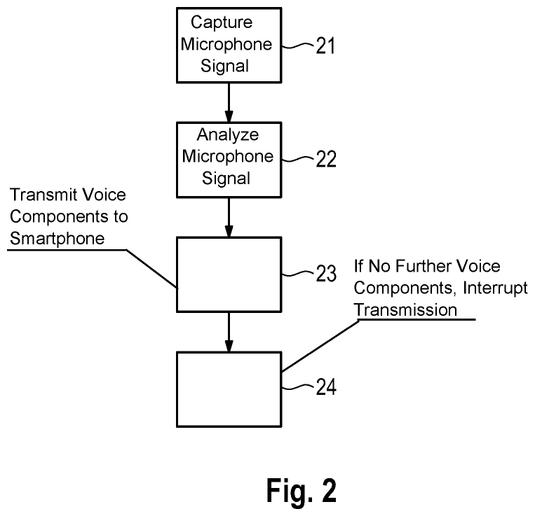

The flow of the process of the transmission of data between the hearing aid 3 and the smartphone 5 is described in detail in FIG. 2. Reference is made to the hearing aid system 1 according to FIG. 1 described earlier. Hearing aids and/or peripheral devices of other designs between which transmission of data takes place can, of course, nevertheless also be used.

At the beginning, a microphone signal of the microphones 9 of the hearing aid 3 is captured (step 21). The microphone signal is analyzed continuously by the voice recognition module 17 and examined for own voice components contained in the microphone signal (step 22).

If voice components of the hearing aid wearer are recognized in the microphone signal, then the subsequent audio sequence is transmitted from there to the smartphone 5 (step 23) by the transmission unit 19 of the hearing aid 3. In the present case the transmission takes place within a time window Δt of 30 seconds. If no own voice components are recognized any more after the time window Δt has elapsed, the transmission is interrupted. Otherwise, the transmission is extended (in each case from the beginning of a new time window Δt to the beginning of the detection of own voice components in the audio sequence) (step 24).

A buffer sequence of the microphone signal is, furthermore, recorded continuously by a recording unit 25. If the total of the reaction times of the total system composed of own voice recognition, the transmission system in the hearing aid, the receiving system in the smartphone 5 and the corresponding voice recognition software of the smartphone 5 is too long, this buffer sequence is transmitted to the smartphone 5 in addition to the audio sequence. It is in this way ensured that, for example, a keyword that is required for the initialization of the voice recognition software of the smartphone 5 that was already spoken before the transmission of the audio sequence is also received by the smartphone 5.

Although not shown here on the illustration, it is particularly advantageous if the hearing aid system 1 contains two hearing aids 3. This is a binaurally coupled hearing aid system 1, in which the two hearing aids 3 are coupled to one another via a magnetic link. The algorithms underlining the own voice recognition (OVD algorithms) are used by both hearing aids 3. The explanations made here relating to the hearing aid system 1 with a hearing aid 3 can here be transmitted analogously to the binaural hearing aid system 1.

The invention is made particularly clear through the exemplary embodiments described above, but is nevertheless not restricted to these exemplary embodiments. Rather further forms of embodiment of the invention can be derived from the claims and the above description.

The following is a summary list of reference numerals and the corresponding structure used in the above description of the invention:
1 Hearing aid system
3 Hearing aid
5 Smartphone
7 Peripheral device
9 Microphone
11 Receiver
13 Battery
15 Signal processing unit
17 Voice recognition module
19 Transmission unit
21 Method step 1
22 Method step 2
23 Method step 3
24 Method step 4
25 Recording unit

1. A method for controlling a transmission of data between at least one hearing aid and a peripheral device of a hearing aid system, which comprises the steps of:
automatically examining a microphone signal captured by the hearing aid for own voice components of a hearing aid wearer; and
transmitting a subsequent audio sequence of the microphone signal from the hearing aid to the peripheral device on a recognition of the own voice components.

2. The method according to claim 1, which further comprises transmitting the subsequent audio sequence to the peripheral device only when and for as long as the own voice components of the hearing aid wearer are recognized in the subsequent audio sequence.

3. The method according to claim 1, which further comprises transmitting the subsequent audio sequence of the microphone signal from the hearing aid to the peripheral device for a predefined period of time after the recognition of the own voice components.

4. The method according to claim 1, which further comprises recording a buffer sequence that precedes the subsequent audio sequence in time continuously by the hearing aid and is stored therein.

5. The method according to claim 4, which further comprises transmitting the buffer sequence from the hearing aid to the peripheral device before the transmission of the subsequent audio sequence.

6. The method according to claim 4, wherein, on the recognition of the own voice components, transmitting the buffer sequence stored up to this point in time to the peripheral device together with the subsequent audio sequence.

7. The method according to claim 4, which further comprises transmitting at least one of the subsequent audio sequence of the microphone signal or the buffer sequence recorded wirelessly from the hearing aid to the peripheral device.

8. A hearing aid system, comprising:
a peripheral device; and
at least one hearing aid having at least one microphone for recording a microphone signal, a voice recognition module for examining the microphone signal for own voice components of a hearing aid wearer, and a transmission unit configured to transmit, on a recognition of the own voice components, a subsequent audio sequence of the microphone signal from said hearing aid to said peripheral device.

9. The hearing aid system according to claim 8, wherein said transmission unit of said at least one hearing aid is configured to transmit the subsequent audio sequence to said peripheral device only when and for as long as the own subsequent voice components of the hearing aid wearer are recognized in the subsequent audio sequence.

10. The hearing aid system according to claim 8, wherein said transmission unit of said at least one hearing aid is configured to transmit, such that after the recognition of the own voice components, the subsequent audio sequence of the microphone signal from said hearing aid to said peripheral device for a predefined period of time.

11. The hearing aid system according to claim 8, further comprising a recording unit for a continuous recording and storage of a buffer sequence that precedes the subsequent audio sequence in time.

12. The hearing aid system according to claim 11, wherein said transmission unit of said at least one hearing aid is configured to transmit, on the recognition of the own voice components in the microphone signal, the buffer sequence stored up to a point in time to said peripheral device together with the subsequent audio sequence.

13. The hearing aid system according to claim 11, wherein said transmission unit of said at least one hearing aid is configured to transmit the buffer sequence from said hearing aid to said peripheral device before the transmission of the subsequent audio sequence.

14. The hearing aid system according to claim 11, wherein said transmission unit of said at least one hearing aid is configured to transmit the subsequent audio sequence of the microphone signal and/or the buffer sequence wirelessly from said hearing aid to said peripheral device.
